(19) United States
(12) Patent Application Publication
(10) Pub. No.: US 2023/0205667 A1
(43) Pub. Date: Jun. 29, 2023

(54) INSTRUMENTATION SYSTEM FOR DETERMINING PERFORMANCE OF DISTRIBUTED FILESYSTEM

(71) Applicant: Seagate Technology LLC, Fremont, CA (US)

(72) Inventors: Anatolii Bilenko, Kyiv (UA); Nikita Danilov, San Francisco, CA (US); Maksym Medvied, Moscow (RU)

(21) Appl. No.: 17/705,207

(22) Filed: Mar. 25, 2022

(30) Foreign Application Priority Data
Dec. 29, 2021 (RU) 2021139546

(51) Int. Cl. G06F 11/34; G06F 16/182

(52) U.S. Cl. CPC G06F 11/3495; G06F 11/3447; G06F 16/182

(57) ABSTRACT

Data access requests targeted to a distributed filesystem are tracked. The data access requests are distributed to different processes running on one more storage servers. For each of the processes, times of events within each of the processes is determined and the events are associated with an event identifier. Data may be stored that such as times of operations, event identifiers, and relationship data between the processes associated with the data access requests. The stored data characterizes different phases of the data access requests, which can be presented to a user for system analysis.

### RELATED APPLICATIONS

This application claims the benefit of priority under 35 U.S.C. § 119(a) of RU Application No. 2021139546, filed 29 Dec. 2021, the disclosure of which is incorporated by reference herein in its entirety.

### SUMMARY

In one embodiment, data access requests targeted to a distributed filesystem are tracked. Each of the data access requests are distributed to a plurality of different processes running on one more storage servers. For each of the plurality of the processes, a time of an event within each of the processes is determined and each of the events is associated with an event identifier. A first data structure associated with each event includes the time and the event identifier and is stored in an instrumentation data store. In the instrumentation data store, a second data structure is recorded comprising relationship data between the processes associated with the data access requests. Elapsed times of different phases of the data access requests are determined using the first and second data structures. One or more of the requests are represented as a timeline indicating the elapsed times of the different phases. The timeline is presented to a user for system analysis.

In another embodiment, data access requests targeted to a distributed filesystem are tracked. Each of the data access requests are distributed to a plurality of different processes running on one more storage servers. For each of the plurality of the processes, a time of an event within each of the processes is determined and each of the events is associated with an event identifier. A first data structure associated with each event includes the time and event identifier and is stored in an instrumentation data store. Elapsed times of different phases of the data access requests are determined using the first data structures. The elapsed times of the different phases of the data access requests are aggregated, and a statistical analysis of the aggregated elapsed times is presented to a user for system analysis.

In another embodiment, data access requests targeted to a distributed filesystem are tracked. Each of the data access requests are distributed to a plurality of different processes running on one more storage servers. For each of the plurality of the processes, a time of an event within each of the processes is determined and each of the events is associated with an event identifier. A first data structure associated with each event includes the time and the event identifier and is stored in an instrumentation data store. In the instrumentation data store, a second data structure is recorded comprising relationship data between the processes associated with the data access requests. One or more of the requests are represented as a graph indicating interactions between the processes that serviced the request, and the graph is presented to a user for system analysis.

The above summary is not intended to describe each embodiment or every implementation of the present disclosure. A more complete understanding will become apparent and appreciated by referring to the following detailed description and claims taken in conjunction with the accompanying drawings. In other words, these and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings.

FIG. 1 illustrates a diagram that illustrates a data center in accordance with embodiments described herein;

FIG. 2 shows an example stack data flow graph for a 3-node system in accordance with embodiments described herein;

FIG. 3 illustrates a data flow graph for a 3-node system in accordance with embodiments described herein;

FIG. 4 shows the timelines for the hierarchy of given requests in accordance with embodiments described herein;

FIG. 5 illustrates examples of event information that may be collected in accordance with embodiments described herein;

FIG. 6 illustrates the request data flow graph of FIG. 3 annotated with events, relations, and attribute data in accordance with embodiments described herein;

FIG. 7 illustrates a process for monitoring performance of a system in accordance with embodiments described herein;

FIG. 8 is a diagram of a distributed storage system used for generating instrumentation data according to an example embodiment;

FIGS. 9 and 10 are bar graphs showing benchmarking of storage performance for the system shown in FIG. 8;

FIGS. 11 and 12 are data flow graphs obtained when instrumenting particular read and write transactions in the system shown in FIG. 8;

FIGS. 13-15 are histograms that show aggregations of various phases of the transactions as shown in FIG. 11; and

FIG. 16 is a data flow diagram showing specific intervals of a write request in the system shown in FIG. 8.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Today, software systems are huge and contain a big number of processes living on different hardware nodes communicating over different types of networks. To have a holistic view of such systems’ operational modes, performance, and observability of properties of different moving parts of the system, it is not enough just to have performance, availability, or reliability characteristic of a single process. Embodiments described herein fill the gap between low-level and high-level profiling, observability, and monitoring tools. The illustrated embodiments are directed to distributed storage arrangements, where persistent storage can be distributed amongst multiple machines, processors, and storages devices. This allows for the gathering, processing, and visualization of high-level and low-level data storage performance and observability samples so that the majority of listed tools’ artifacts can be processed and analyzed in a holistic way.

Existing distributed data storage monitoring tools are generally too high-level and do not allow users to trace the high-level lifecycle of a single request down from the users’ level down to IO operation. Unlike mentioned observability tools, sampling and instrumenting profilers may give some understanding of CPU-bound, or even, IO-bound problems living within a single process. Still, profilers are generally stack-based and may not be as applicable to code that does not use a stack approach, e.g., uses something similar to a multithreaded event-based processing loop approach. Other system-level monitoring tools like dstat, sar, iostat, netstat, and system tap may give a lot of context information regarding the operation of a single-node system, but still may not relate this information to the lifecycle and operation modes of the particular software stack as the lifecycle relates to different network entities that service individual requests.

Embodiments described herein fill the gap between low-level and high-level profiling, observability, and monitoring tools. This allows for the gathering, processing, and visualization of needed high-level and low-level performance and observability samples so that majority of a listed tools’ artifacts can be processed and analyzed in a holistic way.

Embodiments described herein may include a system that is continuously gathering performance and/or observability samples using a framework. The framework may run inside every process in the cluster that handles the appropriate filesystem requests, e.g., every CORTX process in a CORTX cluster. Generally, CORTX is a software-defined object storage system designed for scalability, resiliency, and hardware efficiency and targeted to high-performance computing applications. Among the features of CORTX are no global locks, distribution of metadata management across servers, hierarchical erasure coding, and vertical integration that allows low-level hardware innovations to be addressed in the software, thereby ensuring that new hardware can be quickly integrated. The client interface for a CORTX storage cluster is known as MOTR.

Generally, CORTX is a software layer that abstracts storage access such that an array of drives, controllers, CPUs, etc., (the CORTX cluster) can flexibly manage lower levels of storage to provide the features noted above in a way that is invisible to the clients that use the storage. Processors in a CORTX cluster may launch multiple, separate processes to manage different aspects of the storage (e.g., metadata management, low-level I/O, load balancing, fault management). The processes may communicate with each other using remote procedure calls (RPCs) such as remote direct memory access (RDMA), which is a direct memory access from the memory of one computer into that of another without involving either one’s operating system. Other types of RPCs may be used instead of or in addition to RDMA in a CORTX cluster, e.g., network sockets, shared memory, etc. While CORTX utilizes object-based storage at lower levels, the MOTR interface can provide legacy remote filesystem support such as simple storage service (S3) and network file system (NFS). Note that the CORTX architecture is described here for purposes of illustration and not of limitation, and the instrumentation examples described herein can be applied to any multi-process, distributed computing system, including distributed storage systems that may be or may not be object-based.

Each of the processes in a distributed storage system may provide an instrumentation schema allowing the system to relate and/or discover activities related to the given process and activity inside it with activities in other processes living on a different cluster or client nodes. The processing framework allows transforming gathered samples into a related data flow graph and a set of such graphs can be analyzed statistically to obtain holistic performance information related to any workload running against the system. The data gathered may be stored in log files, relational database, etc., that are accessible over the network.

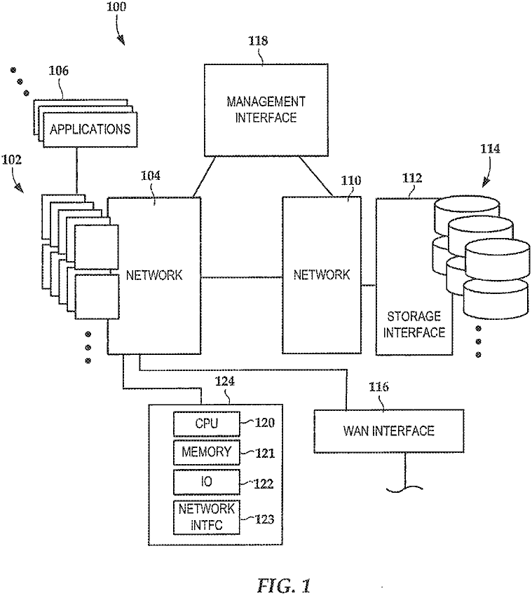

In FIG. 1, a diagram illustrates a software system 100 according to an example embodiment. The software system 100 is implemented using one or more computing nodes 102, which each generally includes computing hardware such as central processing units (CPUs), random access memory (RAM), graphics processing units (GPU), IO hardware, etc. The computing nodes 102 are generally coupled to one or more network segments 104 that allow the compute nodes 102 to communicate with one another and with the rest of the software system 100.

The computing nodes 102 may include individual servers, or each may include a virtual machine, where multiple virtual machines run on a single host server. The computing nodes 102 may each include independently-operating software, e.g., kernels, operating systems, drivers, etc. Generally, the arrangement and configuration of the nodes 102 may be different depending on the high-level functions provided by the software system 100, here represented as applications 106. For example, the software system 100 may be configured as a general-purposes web service provider, offering such services as Web hosting, email hosting, e-commerce, relational database, etc. In other embodiments, the software system 100 may provide a single service such as cloud storage, cloud compute, machine learning compute, paralleled supercomputing, etc.

The applications 106 are also referred to herein as user applications, in that an end-user relies on the applications 106 to perform specified tasks. While some user applications will involve user direct user interactions (e.g., web server, e-commerce) not all user applications will require direct user interface. Even so, a user may ultimately desire that the application perform to some minimum level of service. For example, if the user application performing a compute intensive task such as training a neural network, the user will generally have some expectation that the software system perform adequately (e.g., as measured by time to completion) compared to another computing option, e.g., a high end dedicated workstation. Note that the term user application is not meant to imply only a single user process. For example, a user application may include cluster computing application, in which many thousands of individual processes work across the data center on a single task.

Generally, the applications 106 will use some level of persistent data storage. According to various embodiments, a network 110 is dedicated to storage, e.g., a storage area network (SAN). The storage network 110 is coupled to local storage interfaces 112 (e.g., controller cards) that ultimately send data in and out of storage media 114, e.g., hard disks, solid-state drives (SSDs), optical storage, tape storage, etc.

Also shown in FIG. 1, is a wide-area network (WAN) interface 116 that is accessible by the software system 100. The WAN interface 116 may be coupled to the public Internet, and/or via non-public WANs. A management interface 118 is shown coupled to various components within the software system 100. The management interface 118 may include software that runs dedicated hardware (e.g., management computers) as well as being distributed to other computing nodes and devices throughout the software system 100. The management interface 118 may provide, among other things, interfaces that allow a person or a supervisor program manage aspects such as load balancing, thermal management, failure detection and remediation, etc.

The hardware used by the software system 100 can vary widely, but generally includes conventional computing components as illustrated by example computing device 124. The device 124 includes a processor 120 (e.g., central processing unit, or CPU) that runs software instructions, and may also include embedded firmware. A memory 121 is coupled to the CPU 120, and may include any combination of volatile memory (e.g., random access memory, or RAM) and non-volatile memory (e.g., flash memory, magnetic storage). The CPU 120 communicates with the memory 121 and other peripherals via IO circuitry 122, which may include memory busses, peripheral busses, etc. An example of a peripheral device is shown as network interface 123, which facilitates communicating via the networks 104. Note that the software system 100 need not be tied to a particular location, and can use similarly configured hardware and software processes that are remotely located and accessible via WAN interface 116.

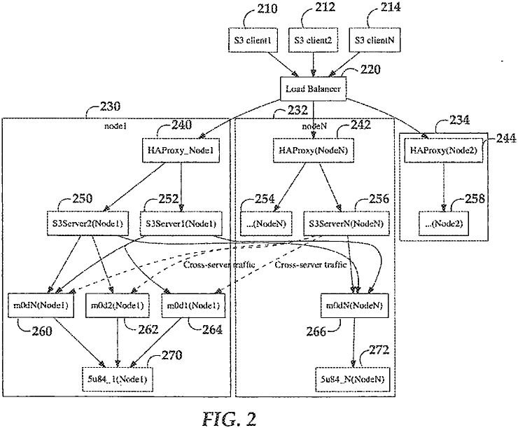

FIG. 2 shows a stack data flow graph for an example 3-node system in accordance with embodiments described herein. For purposes of this disclosure, a “stack” refers not only to location of executed instructions within a single process, but a collection of such single-process stacks as they are performed in sequence using RPCs. Also note that such a stack concept may include branches, where process initiates multiple RPCs with different processes in parallel. Parallel processing may be represented using graphs, and/or as separate, non-branching sequences. In FIG. 2, each request may initiate a plurality of requests and sub-requests. In this example, a first client 210 initiates a first request, a second client 212 initiates a second request, and a third client 214 initiates a third request. A load balancer 220 is used to efficiently distribute the sets of requests to each of the three nodes 230, 232, 234. Each node 230, 232, 234 then generates sub-requests. While the example shown in FIG. 2 shows a system having three nodes, it is to be understood that any number of nodes may be used.

The high availability (HA) proxies 240, 242, 244 offer load balancing and proxying for TCP and HTTP-based applications. The HA proxies are used to balance traffic from the client to simple storage service (S3) servers 250, 252, 254, 256, 258. The S3 servers provide an object storage service (e.g., CORTX) with high data availability, durability, scalability, performance, and security. The S3 servers are used as a protocol adapter to translate S3 protocol into client MOTR protocol, indicated at nodes 260, 262, 264, and 266. Note that other legacy network storage protocols can be used instead of S3, such as network file service (nfs). The MOTR protocol is part of the CORTX object file system and is used in a distributed object storage system, targeting mass capacity storage configurations. Because the underlying storage architecture used by CORTX may be different than the filesystem view provided by S3, the protocol adapter ensures legacy support while providing additional CORTX features described above. To ensure the most efficient storage utilization, MOTR interacts directly with block devices (e.g., hard disk drives, solid state drives, drive arrays), here shown as storage enclosures 270, 272. The MOTR architecture is a more general storage system that provides an optional file system interface. This allows wider range of deployments, including cloud. The features of CORTX MOTR include: scalability, fault-tolerance, fast network RAID repairs, observability, extensibility, extendibility, support for flexible transactions, and portability.

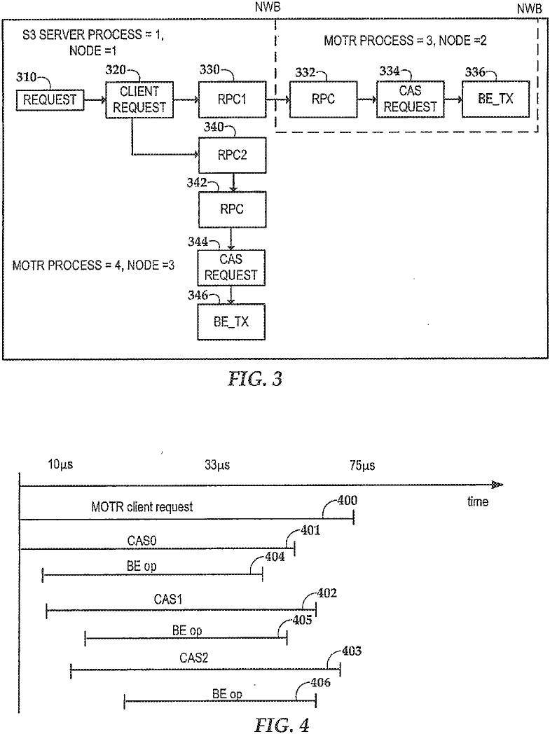

An associated request data flow graph with three nodes is shown in FIG. 3. A server process node handles higher-level storage requests and MOTR process nodes handle the distributed completion of those requests. The flow graph shows the start, finish, and any time spent in the various phases for all of the requests. The relationship of all the requests is also shown. Other information that can be shown in the request flow graph includes number of megabytes each request handles, and/or a number of resends for remote procedure calls (RPCs). Generally, a request 310 is a request for a storage operation such as read, write, verify, etc., on a distributed/clustered file system. The request 310 may be broken into smaller sub-requests and/or parallel requests of a distributed file system. Therefore, the execution of the request 310 can be distributed to different threads, processes, virtual machines and/or physical machines within the system. To enable the distributed processing of a request, a single client request may be broken into a number of RPC calls on the local environment using inter-thread or inter-process communications (e.g., shared memory, pipes, localhost networking, etc.) and/or by making RPC calls to a remote machine via networking and message passing interfaces.

In the example shown in FIG. 3, the request 310 is received at a first node. A client request 320 initiates a first RPC 330 and a second RPC 340 in the first node. The first RPC 330 triggers an RPC 332 in the second node. These RPC calls can be executed in parallel on different processes, and this is indicated by the branching of two lines from the request 320. As indicated by the dashed line labeled network boundary (NWB), the RPC 332 is sent over a network to the second node. The RPC 332 initiates a content addressed storage (CAS) request 334, which is processed by the metadata back end (BE). Generally, CAS is a way to store information so it can be retrieved based on its content, not its location, and is often associated with object-based storage. For example, a hash of the content can be used to index the information. This differs from location addressed storage, where an address (e.g., logical block address) and size is used to access information files.

The metadata BE is a module presenting an interface for a transactional local meta-data storage. The BE users manipulate and access meta-data structures in memory, and the BE maps this memory to persistent storage. The user groups meta-data updates into transactions, and the BE ensures that transactions are atomic in the face of process failures. The BE provides support for a few frequently used data-structures, such as double-linked list, B-tree and extmap.

The BE transaction (BE_TX) 336 is a collection of updates. The user adds an update to a transaction by capturing the update’s region. When the user explicitly closes a transaction, the BE guarantees that the closed transaction is atomic with respect to process crashes that happen after transaction close call returns. That is, after such a crash, either all or none of transaction updates will be present in the segment memory when the segment is opened next time. If a process crashes before a transaction closes, BE ensures that none of transaction updates will be present in the segment memory. The second RPC 340 triggers an RPC 342 in the third node. The RPC 332 initiates a column address select (CAS) request 344, which is processed.

FIG. 4 shows the timelines for the hierarchy of given requests in accordance with embodiments described herein. In this example, a single MOTR client request 400 is broken into three CAS requests 401-403. Each of these CAS requests 401-403 results in an respective back-end transaction 404-406. Note that these transactions can be used to represent the performance at different levels of granularity, e.g., total overall client request, parallel CAS requests, and BE operations. This type of timeline can be presented to a system administrator or other user to indicate the elapsed times of the different phases of the request 400 and/or any sub-transactions or sub-requests.

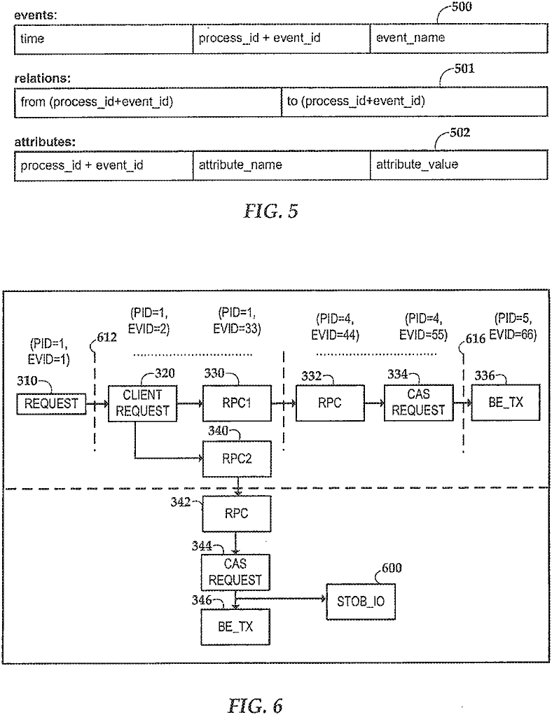

In order to reach a state where all of the pertinent information can be easily gathered and/or aggregated, an aggregation framework may support the gathering of a sufficient amount of events without performance or availability implications. This may be done by collecting various information about the events. An example of information that may be collected is shown in FIG. 5. Various event data may be collected for one or more events and stored in an instrumentation data store (e.g., database, log files, etc.), which may include at least some non-volatile memory storage, although volatile memory may be used as well. The event data structure 500 includes an ordered pair of process ID and event ID which uniquely identifies an event. This ordered pair is used in a relation data structure 501 that maps a relation between two events, in particular a “from-to” relation, e.g., as an event is propagated through different RPCs. In this example, the time of the event, and the event name may also be included in the event data structure 500. Relationships between event and/or processes and other parts of the system may be collected and stored using the relationship data structure 501. The relationship data structure 501 may be used to forward trace an event from its origination or triggering operation (e.g., client request 400 in FIG. 4) to all lower-level events that resulted from that operation (e.g., BE operations 404-406). The relationship data structure 501 may also be used to reverse trace a low level operation (e.g., BE operations 404) back to the highest level operation that triggered the low-level operation (e.g., client request 400).

An attribute data structure 502 may be used to record various attributes of the event that are collected. The attributes may comprise one or more of size of a request, a type of request, and a time to complete a particular event, request identifier or any other system identifier related to the request, for example The process ID and event ID may be associated with at least one attribute. Each attribute may be associated with an attribute name and/or an attribute value.

The data shown in FIG. 5 can be automatically gathered and logged for access by a user terminal, e.g., by a system administrator. The data gathered in this way can provide sufficient information to generate graphical representations of individual requests as shown in FIGS. 2-4, for example, for presentation to an end user such as a system administrator. Other representations may include textual representations (e.g., tables, summaries). In one embodiment, the initiation of a request will generate a root event 500 with a process ID and event ID, and these IDs can be used to find any related events via the relationship data structure 501. The relationship structures 501 can be iteratively found, and any new identifiers can be continued to be queried until all events related to the root event are found. This data will naturally form a graph structure that can be represented in a graphical display. The data structures shown in FIG. 5 may also be aggregated to find statistical data, such as average times for each phase of a request. For example, each phase of the request (e.g., backend read or write) may have labels recorded in the attribute value field and/or event name field that indicates which phase of the request the event belongs. In such a case, these labels can be queried to determine the event times.

FIG. 6 illustrates the request data flow graph of FIG. 3 annotated with events, relations, and attribute data in accordance with embodiments described herein. As shown, it can be observed that various elements are labelled with an associated process ID (PID) and event ID (EVID). The relationships may be shown. For example, the events occurring between request 310 and client request 320 indicated by line 612 may be recorded as a first relation (using relation structure 501 in FIG. 5), the relation stored as: rel(from_PID=1, from_EVID=1 to_PID=1, to_EVID=2). Similarly, the event line 616 may show recorded as a second relation between CAS request 334 and BE operation 336 as follows: rel(from_PID=4, from_EVID=55, to_PID= 5, to_EVID=66). In some embodiments other information may be shown as an alternative or as an addition to the information shown in FIG. 6. Also shown in FIG. 6 is Stob_IO 600, which is a state machine representing asynchronous read/write disk operation.

To process each request (e.g., request 310 in FIGS. 3 and 6 ) in the system, a defined number of RPC messages are sent to the defined number of servers. At these servers, the messages will be processed and converted into an appropriate number and type of sub-operations, such as executed transactions, IO requests, and other time-consuming operations. Variance in the time needed to process each sub-operation can be analyzed. If such variance exceeds some value, it is treated as an anomaly. For example, it may be assumed that all BE operations 336, 346 for this and similar request should take a similar amount of time, or at least an amount of time that can be scaled with the size of the request.

Combining distributions of all times needed to process all sub-request of the request into a single matrix provides a way to analyze all anomalies of the request (variations of the processing time). Also, in the number of activities (RPCs, transactions, IO requests) needed to complete the request changes, this can be another type of the anomaly. The reason for such anomalies can be disk degradation, non-typical load, failures, etc.

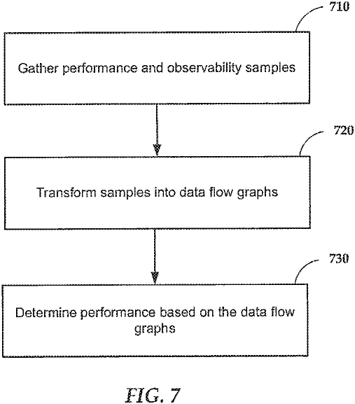

FIG. 7 illustrates a process for monitoring performance of a system in accordance with embodiments described herein. The method involves, during operation of a software system, gathering 710 one or more of performance and observability samples, which may be at least associated with data access requests targeted to a distributed filesystem of a storage system. The gathered samples are transformed 720 into one or more data flow graphs. The one or more data flow graphs may at least show phases of the data access requests on different nodes and processes of the storage system. Holistic performance of the software system is statistically determined 730 based on the one or more data flow graphs.

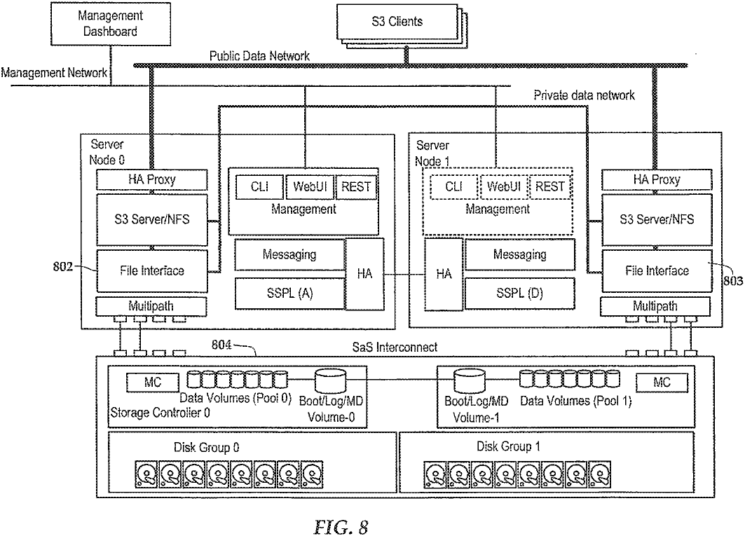

In one example, systems and methods described above can be used for bottleneck identification and optimization. An instrumentation infrastructure as described above can be used to gather and display overall performance numbers and characteristics over the entire distributed software stack. In FIG. 8, a block diagram shows a dual node cluster that was used to demonstrate a tool infrastructure according to an example embodiment. The file interfaces 802, 803 may use any type of software interface, (MERO was used in this example), and utilize a storage rack 804 with drive arrays for data storage.

Analysis of performance of this system was based on insights from queueing theory for understanding dynamics of the system and network flow problem for static analysis. Additionally spatial and time locality analysis is used to analyze performance in comparison with raw performance numbers from the storage array. The tools used for this analysis includes a timing tool for hierarchical timing analysis as shown in FIGS. 3-6. Additional tools include those which gather data for analysis of queues, fragmentation, locks, drive array workload pattern, CPU-performance hot path, block layer analysis, context switch, page fault, CPU-on/off, etc.

A set of scripts for automation of performance work run in predefined environment were developed for data and metadata path tests, workload scripts for various S3 protocol-related tests, automation of development test results retrieval, and automation of reporting. Note that because these tools are used for debugging performance of asynchronous system, traditional tools like CPU-profilers, memory profilers, etc., commonly used for analysis in traditional synchronous applications may not be usable here. The performance tools utilized fit the asynchronous nature of the system and are able to show numbers that can be clearly interpreted during performance sessions.

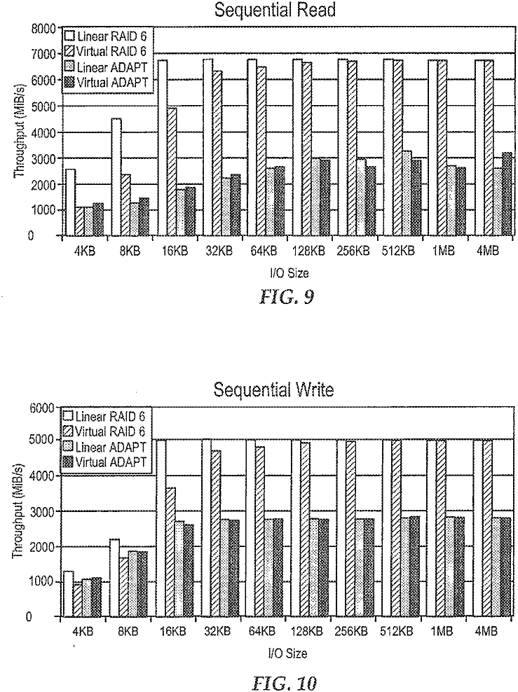

To start work with performance optimization of software stack, a clear understanding of physical limitations should be measured, which include system structure, raw data flows measured in megabytes per second and operations/requests per second or in-flight. Example results of this type of measurement are shown in the graphs of FIGS. 9 and 10. Note that these measurements were made for both virtual and linear Redundant Array of Independent Disk (RAID) Level 6 and Autonomic Distributed Allocation Protection Technology (ADAPT) configurations. The ADAPT configuration is an erasure encoding solution which is an alternative to traditional RAID types that uses a protection scheme that distributes the parity across a larger set of HDDs or SSDs than typical with RAID.

The first case examined in detail is reading of data resulting from S3 PUT requests and that are satisfied (in this example) using the Clovis interface. Clovis is associated with MERO and is analogous to the MOTR interface used with CORTX. The request is shown in the graph of FIG. 11, and contains three Clovis DIX requests, one Clovis COB request and four IO (READV) requests. The DIX and COB requests deal with the mapping from S3 to object storage, and the IO requests deal with the lower level read requests. This graph shows the most significant time is taken in Clovis[io] (READV) requests. By examining a large number of such requests, it is found that the Clovis[io] operations take 120 ms in average, compared to a potential performance level of 62 ms (e.g., found using the benchmark measurements that produced FIGS. 9 and 10). The reason for this difference is likely due to a non-sequential load pattern. The synchronous parts of this request take 1 ms on average and are insignificant in comparison with Clovis[io] parts.

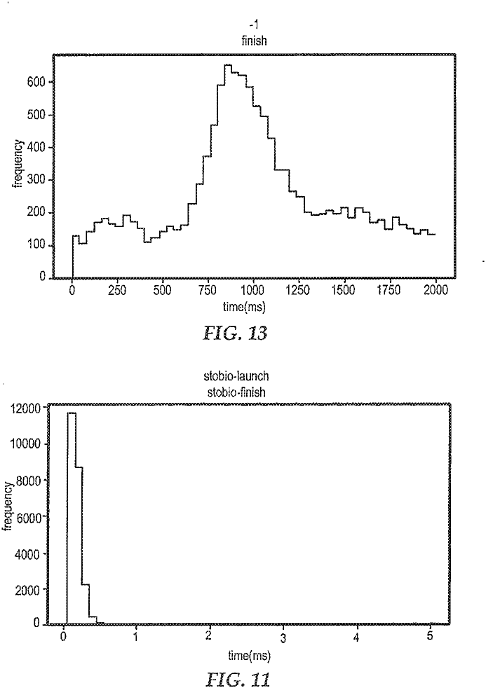

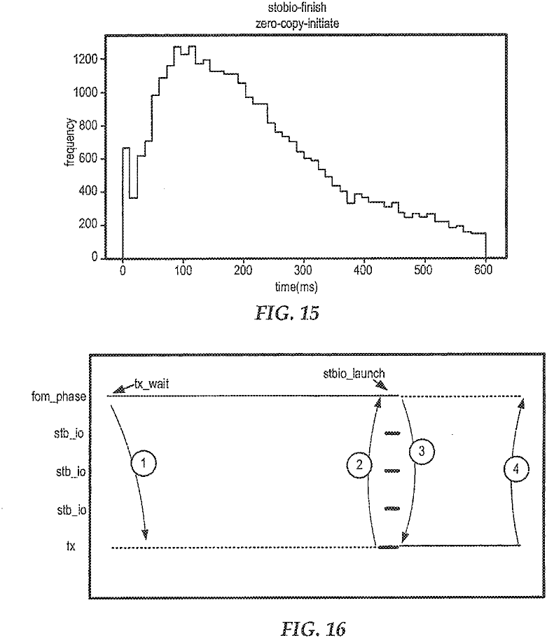

Data shown in FIG. 11 can be gathered for a collection of similar requests and used to form histograms, as shown by way of example in FIGS. 13-15. For this example, a fragmentation analysis indicates initial data is not highly fragmented and was divided by chunks of 32 m with block is of 1 m. In some cases, resends are seen but they are not major. On scale out analysis it was found that sending more than 256 Clovis requests in parallel could give performance comparable with the benchmark measurements of the storage subsystem.

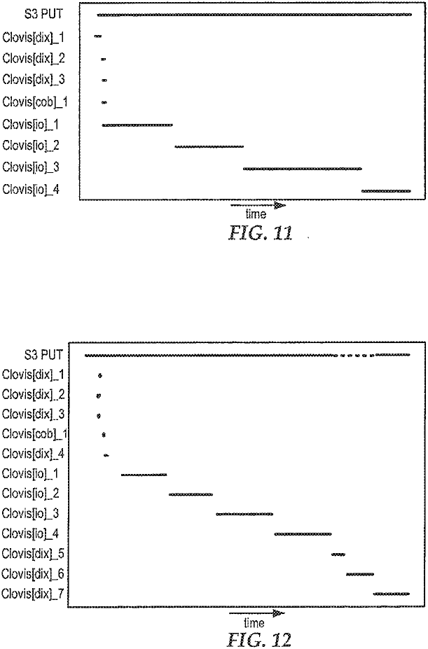

The analysis of write performance may not be as straightforward as read performance, but has some similar aspects. An example write measurement is shown in FIG. 12. On the top level, write cases start from S3 PUT request containing four Clovis DIX requests (Clovis[dix]_1 to Clovis[dix]_4) and one Clovis COB request (Clovis[cob]_1) preparing a metadata for buckets and object metadata on MERO level. None of these are significant to performance. This is followed by four Clovis IO requests (Clovis[io]_1 to Clovis[io]_4) and three Clovis DIX requests (Clovis[dix]_5 to Clovis[dix]_5). The latter take significant amounts of time therefore should be analyzed carefully.

The WRITEV request includes significant intervals that are analyzed, an example timeline of which is shown in FIG. 16. The intervals include a backend transaction opening interval (1-2), actual data IO interval (2-3), and backend transaction logging interval (3-4). The opening interval (1-2) is a sum of BE transaction grouping-active and opening grouping intervals. The interval (1-2) is distributed around 500 ms, which can be found using a histogram (not shown), as are the other interval times. Actual data IO (2-3) takes around 30 ms, which means that system is underloaded during write case because it’s expected to have latencies around 60 ms. The backend transaction logging interval (3-4) takes around 200 ms. This timing indirectly affects interval (1-2) due to backend transactional group logic.

According to fragmentation analysis, initial data is highly fragmented and it is divided by chunks of 16 K with block number of 2 K. In some cases, resends are seen but they are not major. The DIX PUT request also includes intervals which can be similarly analyzed. These intervals include an index lock acquisition interval, which in > 70% of cases takes less than 10 ms and a backend transaction opening interval, which in >50% of cases takes more than 10 ms. These intervals can be similarly plotted via histograms for analysis of performance, anomalies, etc. In summary, the illustrated instrumentation scheme can be used in server applications with an event-driven architecture model containing more than one server application living in different process and/or node. In such applications, there may be a need to perform profiling and analysis of the code with consequent code improvements. To provide a smooth profiling and analysis, such a system can gather statistics of the execution of multiple instances of server applications and connect related request flows going through all these applications together. Different types and/or stages of the request flows can be separately congregated and analyzed (e.g., using histograms and the like) in order to better understand bottlenecks and other issues that may impede optimum performance.

To have sufficient performance samples, such a system may include an aggregation framework which is able to gather such a large amount of data. For example, the example systems described above may gather 20-40MB/s of samples per node. Low-level tools such as perf or other profilers target different scenarios (stack-based profiling) therefore cannot fill the gap in fine grained profiling of servers where related instances live inside different threads, processes, applications, nodes, etc. The above-described instrumentation schema can be used in those cases and helps to aggregate observability samples into timelines.

Such an instrumentation tool may provide features such as cluster-wide observability with tunable granularity level (from high-level activities to low-level bits and bytes monitoring (e.g., access patterns). The instrumentation tool facilitates cluster-wide, end-to-end performance debugging with consequent code improvements by means for optimization of the lifecycle long of lived requests and request-related state-machines. The system may be used as a data mining framework for the analysis of many aspects of the system behavior including and but limited to workload analysis. For example, such analysis may detect anomalies, characterize access patterns in near-real time, analyze request flows in near-real time, etc.

In large systems, when one bottleneck is fixed many new bottlenecks may show up. The above-described instrumentation tool provides a way to react on the regression in the behavior of the system and to provide a reaction by means of automated run-time analysis. Such regression can provide insights not only in terms of the final performance metrics but in terms on intermediate performance which are different in the context of microbenchmarks.

Another use for the above-described instrumentation tool is modeling. Tools such as Analysis and Diagnostics Database (ADDB) can provide data that is sufficiently detailed to allow the simulation of file system behavior. A simulator can use a subset of stored ADDB records as the input for the simulation, which is combined with the instrumentation tools described above. The ADDB records, among other things, provide accurate traces of all calls made by applications to Mero or similar file system interface. The simulator “re-executes” these traced calls. The most basic use of such incoming traces to is calibrate the simulator until the output produced, in the form of ADDB records, matches actual system behavior. With a simulator, simulations can be run without access to actual customer data or customer hardware, providing the ability to remotely debug or model the impact of changes to a system.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety for all purposes, except to the extent any aspect directly contradicts this disclosure.

All scientific and technical terms used herein have meanings commonly used in the art unless otherwise specified. The definitions provided herein are to facilitate understanding of certain terms used frequently herein and are not meant to limit the scope of the present disclosure.

The terms “coupled” or “connected” refer to elements being attached to each other either directly (in direct contact with each other) or indirectly (having one or more elements between and attaching the two elements). Either term may be replaced to “couplable” or “connectable” to describe that the elements are configured to be coupled or connected. In addition, either term may be modified by “operatively” and “operably,” which may be used interchangeably, to describe that the coupling or connection is configured to allow the components to interact to carry out functionality.

As used herein, the term “configured to” may be used interchangeably with the terms “adapted to” or “structured to” unless the content of this disclosure clearly dictates otherwise.

The singular forms “a,” “an,” and “the” encompass embodiments having plural referents unless its context clearly dictates otherwise.

The term “or” is generally employed in its inclusive sense, for example, to mean “and/or” unless the context clearly dictates otherwise. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. A method, comprising:
tracking a data access request targeted to a distributed filesystem, the data access request being distributed to a plurality of different processes running on one more storage servers;
for each of the plurality of the processes, determining a time of an event related to processing of the data access request within each of the processes and associating the event with an event identifier;
associating with each event a first data structure that includes the time and the event identifier of the event, the first data structures being stored in an instrumentation data store;
recording, in the instrumentation data store, a second data structure comprising a from-to relationship data between the processes associated with the data access request;
determining elapsed times of different phases of the data access request using the first and second data structures;
representing data access request as a timeline indicating the elapsed times of the different phases; and
presenting the timeline to a user for system analysis.

2. The method of claim 1, wherein the timeline is presented as a data flow graph showing lifecycles of the data access request across the one or more storage servers from a user level down to input-output operations.

3. The method of claim 1, wherein for the data access request, a first pair of the different processes are run in parallel.

4. The method of claim 1, wherein the relationship data between the processes indicates execution of a remote procedure call from a first process to a second process.

5. The method of claim 4, wherein the timeline shows a number of resends for the remote procedure call.

6. The method of claim 1, wherein the distributed filesystem comprises an object-based filesystem.

7. The method of claim 1, further comprising:
aggregating the elapsed times of the different phases of the data access request; and
providing the user with a statistical analysis of the aggregated elapsed times.

8. The method of claim 1, wherein the timeline presented to the user indicates bottlenecks in the distributed filesystem.

9. The method of claim 1, wherein the timeline presented to the user indicates anomalies in the distributed filesystem.

10. A system comprising at least one processor, the processor operable via instructions to perform the method of claim 1.

11. A method, comprising:
tracking a data access request targeted to a distributed filesystem, the data access request being one of a read, write, and verify operation that is broken into sub-requests that are distributed to a plurality of different processes running on one more storage servers;
for each of the plurality of the processes, determining a time of an event related to processing of the data access request within each of the processes and associating the event with an event identifier;
associating with each event a first data structure that includes the time and the event identifier of the event, the first data structures being stored in an instrumentation data store;
determining elapsed times of different phases of the data access request using the first data structures;
aggregating the elapsed times of the different phases of the data access request to trace lifecycles of the data access request across the one or more storage servers from a user level down to input-output operations; and
presenting a statistical analysis of the aggregated elapsed times to a user for system analysis.

12. The method of claim 11, wherein the distributed filesystem comprises an object-based filesystem.

13. The method of claim 11, wherein the statistical analysis presented to the user indicates bottlenecks in the distributed filesystem.

14. The method of claim 11, wherein the statistical analysis presented to the user indicates anomalies in the distributed filesystem.

15. The method of claim 11, wherein presenting the statistical analysis of the aggregated elapsed times to the user comprises presenting one or more histograms.

16. A system comprising at least one processor, the processor operable via instructions to perform the method of claim 11.

17. A method, comprising:
tracking a data access request targeted to a distributed filesystem, the data access request being distributed to a plurality of different processes running on one more storage servers;
for each of the plurality of the processes, determining a time of an event related to processing of the data access request within each of the processes and associating the event with an event identifier;
associating with each event a first data structure that includes the time and the event identifier of the event, the first data structures being stored in an instrumentation data store;
recording, in the instrumentation data store, a second data structure comprising from-to relationship data between the processes associated with the data access request;
representing the data access request as a graph indicating interactions between the processes that serviced the data access request; and
presenting the graph to a user for system analysis.

18. The method of claim 17, wherein for the data access request, a first pair of the different processes are run in parallel, the graph comprising a branch indicating the different processes.

19. A system comprising at least one processor, the processor operable via instructions to perform the method of claim 17.

20. The method of claim 1, wherein the data access request is one of a read, write, and verify operation that is broken into sub-requests that are distributed to the plurality of different processes running on the one more storage servers, the timeline showing a lifecycle of the data access request across the one or more storage servers from a user level down to input-output operations.
